(19) United States
(12) Patent Application Publication
(10) Pub. No.: US 2014/0228111 A1
(43) Pub. Date: Aug. 14, 2014

(54) APPARATUS AND METHOD FOR DETECTING ABNORMAL ACCOUNT

(71) Applicant: Myeong Jin Yun, Seoul (KR)

(72) Inventor: Myeong Jin Yun, Seoul (KR)

(73) Assignee: Neople, Inc., Gangnam-gu, SEOUL (KR)

(21) Appl. No.: 14/351,527

(22) PCT Filed: Dec. 28, 2011
(86) PCT No.: PCT/KR2011/010203

§ 371 Date: Apr. 11, 2014

(30) Foreign Application Priority Data
Oct. 13, 2011 (KR) 10-2011-0104798

(51) Int. Cl. A63F 13/00

(52) U.S. Cl. CPC A63F 13/00; A63F 2300/5586
USPC 463/29

(57) ABSTRACT

An apparatus and method are provided, which determine whether the abnormal account performs an abnormal trade with at least one account, assign an abnormality score to the abnormal account according to whether the abnormal account performs the abnormal trade, and control the abnormal account with a control level corresponding to a predetermined reference score when the abnormality score assigned to the abnormal account is higher than or equal to the predetermined reference score.

### TECHNICAL FIELD

The present invention relates to an apparatus and method for detecting an abnormal account, and more particularly, to an apparatus and method for assigning an abnormality score to a specific account to restrict the specific account assigned a predetermined reference score or a higher score.

### BACKGROUND ART

Nowadays, an online game market is increasing drastically. In keeping with this trend, various game companies are investing a great deal of time and effort on development of online games. Consequently, the online games are developing not only in quality but also in quantity.

Through the online games, a user may experience a society in cyber space, where economic activities are performed as in the actual life, using items and game goods used by a character corresponding to the user.

For example, the user of the online game may decorate or reinforce the character by obtaining the items and the like using the character. In addition, the user may purchase items necessary for the character by obtaining the game goods. Also, the user may sell the obtained items to purchase the game goods.

However, these days, the user may purchase game goods with actual money and easily obtain game goods by applying the game goods purchased with actual money. Furthermore, conversely, the user may sell the game goods obtained through the online game to other users by receiving actual money.

Recently, a social problem is arising in that some users prepare a dedicated large-scale computer to professionally obtain items and game goods through online games and sell the items and game goods for actual money.

### DISCLOSURE OF INVENTION

### Technical Goals

### Technical Solutions

According to an aspect of the present invention, there is provided an abnormal account detection apparatus including a detection unit to detect an abnormal account from at least one account in a game; a determination unit to determine whether the abnormal account performs an abnormal trade with at least one account; an abnormality score assigning unit to assign an abnormality score to the abnormal account according to whether the abnormal account performs the abnormal trade; and an account control unit to control the abnormal account with a control level corresponding to a predetermined reference score when the abnormality score assigned to the abnormal account is higher than or equal to the predetermined reference score.

The detection unit may determine that the at least one account is the abnormal account when the at least one account sells at least one item of game goods a predetermined number of times or more.

The detection unit may inspect transaction data between the abnormal account and at least one other account and, when game goods are traded at a price less than or equal to a predetermined reference price, determines that the at least one account and the at least one other account is the abnormal account.

The detection unit may determine the at least one account to be the abnormal account when the at least one account repeats the same pattern.

The abnormality score assigning unit may inspect transaction data between the abnormal account and at least one other account and, when game goods are traded at a price less than or equal to a predetermined reference price, assigns the abnormality score to the abnormal account and the at least one other account.

The account control unit may control the at least one other account with a control level corresponding to the predetermined reference score when the abnormality score assigned to the at least one other account is higher than or equal to the predetermined reference score.

The abnormality score assigning unit may assign the abnormality score to the abnormal account when the abnormal account sells at least one item of game goods a predetermined number of times or more.

The abnormality score assigning unit may assign the abnormality score to the abnormal account when the abnormal account repeats the same pattern.

The account control unit may cancel control of the abnormal account when the abnormal account satisfies a predetermined condition.

The abnormality score assigning unit may additionally assign the abnormality score to the abnormal account when the abnormal account satisfies a predetermined condition.

The abnormality score assigning unit may deduct the abnormality score of the abnormal account when the abnormal account satisfies a predetermined condition.

The account control unit may permanently ban the abnormal account from trading game goods.

The account control unit may temporarily ban the abnormal account from accessing the game.

The account control unit may permanently ban the abnormal account from accessing the game.

According to another aspect of the present invention, there is provided an abnormal account detection method including detecting an abnormal account from at least one account in a game; determining whether the abnormal account performs an abnormal trade with at least one account; assigning an abnormality score to the abnormal account according to whether the abnormal account performs the abnormal trade; and controlling the abnormal account with a control level corresponding to a predetermined reference score when the abnormality score assigned to the abnormal account is higher than or equal to the predetermined reference score.

### BRIEF DESCRIPTION OF DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a structure of an abnormal account detection apparatus according to an embodiment of the present invention;

FIG. 2 is a flowchart illustrating a method for detecting an abnormal account, according to an embodiment of the present invention;

FIG. 3 is a diagram illustrating an example of log data resulting from detection of an abnormal account, according to an embodiment of the present invention.

### BEST MODE FOR CARRYING OUT THE INVENTION

Reference will now be made in detail to exemplary embodiments of the present invention, examples of which are illustrated in the accompanying drawings.

In the following description, when it is determined that a detailed description of well-known functions related to the present invention and the construction thereof would make the gist of the present invention obscure, they will be omitted. The terminology used herein is for the purpose of describing particular embodiments only and the definition may be varied according to the intention of a user, an operator, or customs. Therefore, the terms and words should be defined based on a description of this specification. Like reference numerals refer to the like elements throughout.

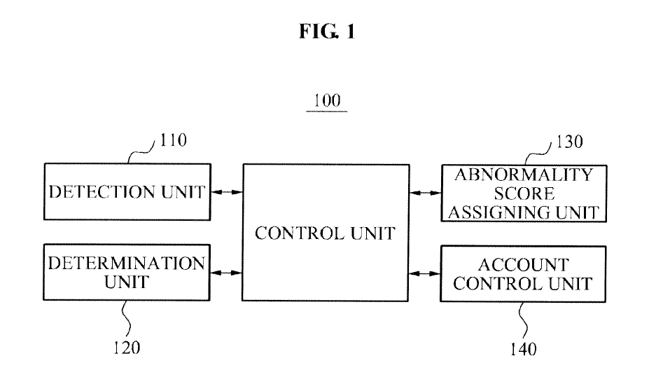

FIG. 1 is a block diagram illustrating a structure of an abnormal account detection apparatus 100 according to an embodiment of the present invention.

Referring to FIG. 1, the abnormal account detection apparatus 100 may include a detection unit 110 for detecting an abnormal account from at least one account in a game, a determination unit 120 for determining whether the abnormal account performs an abnormal trade with at least one account, an abnormality score assigning unit 130 for assigning an abnormality score to the abnormal account according to whether the abnormal account performs an abnormal trade, and an account control unit 140 for controlling the abnormal account when the abnormality score assigned to the abnormal account is higher than or equal to a predetermined reference score, by a control level corresponding to the predetermined reference score.

According to the embodiment of the present invention, the abnormal account detection apparatus 100 assigns the abnormality score to the abnormal account when a user registered with the abnormal account performs an abnormal game behavior according to a particular behavior pattern. Accordingly, the abnormal account detection apparatus 100 may control an account assigned the abnormality score higher than or equal to a predetermined reference score.

For example, when a user of an account performs hacking, hoarding and cashing of game goods, and the like, the abnormal account detection apparatus 100 may track a hacking pattern, a hoarding and cashing pattern, a game behavior pattern such as repetitive hunting and the like, thereby determining the corresponding account to be the abnormal account.

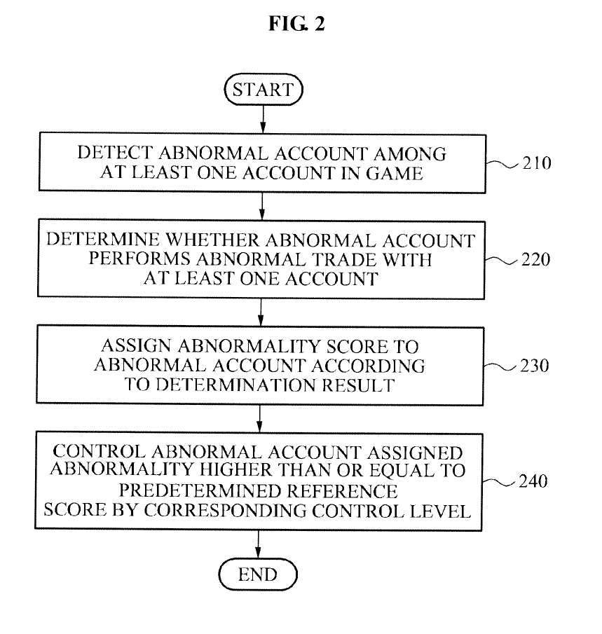

Hereinafter, a method of detecting an abnormal account according to an embodiment of the present invention will be described with reference to FIG. 2.

FIG. 2 is a flowchart illustrating a method for detecting an abnormal account, according to an embodiment of the present invention.

In operation 210, the abnormal account detection apparatus 100 according to the embodiment of the present invention may detect the abnormal account from at least one account in a game using the detection unit 110.

According to an aspect of the present invention, when the at least one account sells at least one item of game goods a predetermined number of times or more, the detection unit 110 may determine the at least one account to be the abnormal account.

When the user sells particular items, for example, a quality item, a professional item, a material item, a consumable item, and the like, to a game store an N-number of times consecutively, the detection unit 110 may detect such a behavior of the user and accordingly determine an account corresponding to the user to be the abnormal account.

The detection unit 110 may activate a flag for setting information on the detected user, the information stored in a database (DB), to ‘suspicious user according to the hacking pattern.’

Here, when a behavior pattern of the abnormal account, the behavior pattern belonging to a category of abnormal trading, is disclosed, the abnormal account detection apparatus 100 may increase an abnormality score related to the abnormal account.

The detection unit 110 may inspect transaction data between the at least one account and at least one other account. When the game goods are traded at a price less than or equal to a predetermined reference price, the detection unit 110 may determine the at least one account and the at least one other account to be the abnormal accounts.

In trading of the game goods between two accounts, when one of the two accounts obtains X times as much profit or more of goods or game money as an average price of a game-goods auction house, the detection unit 110 may determine the corresponding account to be the abnormal account.

In this case, the detection unit 110 may activate a flag for setting the information on the user of the abnormal account, the information stored in the DB, to ‘suspicious user according to the hoarding and cashing pattern.’

When the at least one account repeats the same pattern, the detection unit 110 may determine the at least one account to be the abnormal account.

For example, when a certain user completes an instant dungeon an N-number of times consecutively in one game, the detection unit 110 may determine an account of the user to be the abnormal account.

In this case, the detection unit 110 may activate a flag for setting the information on the user of the abnormal account, the information stored in the DB, to ‘suspicious user according to an illegal program use pattern.’

Here, when the user completes a particular instant dungeon, the abnormal account detection apparatus 100 may not determine the account of the user to be abnormal.

In operation 220, the abnormal account detection apparatus 100, according to the embodiment of the present invention, may determine whether the abnormal account performs an abnormal trade in game goods with at least one account.

In operation 230, the abnormal account detection apparatus 100 may assign an abnormality score to the abnormal account using the abnormality score assigning unit 130, according to whether the abnormal account performs the abnormal trade.

According to an aspect of the present invention, the abnormality score assigning unit 130 may inspect transaction data between the abnormal account and at least one other account, and when the game goods are traded at a price less than or equal to a predetermined reference price, may assign the abnormality score to the at least one abnormal account and the at least one other account.

In trading of the game goods between two accounts, when the trade is determined to be abnormal since the game goods or game money is traded at a price at least N times higher or lower than a market price, the abnormality score assigning unit 130 may consider the trade to be abnormal and increase the abnormality score of the corresponding user.

In trading through a game store established by one user of the two accounts, when the game goods or game money is traded at the price at least N times higher or lower than a market price, the abnormality score assigning unit 130 may consider the trade to be abnormal and increase the abnormality score of the corresponding user.

In trading through a game-goods auction house, when the game money is traded at the price at least N times higher or lower than a market price, the abnormality score assigning unit 130 may consider the trade to be abnormal and increase the abnormality score of the corresponding user.

When N%, or more, of game money is transferred from one of the two accounts to the other through a game postal service, the abnormality score assigning unit 130 may consider the trade to be abnormal and increase the abnormality score of the corresponding user.

When the abnormal account sells at least one item of the game goods a predetermined number of times or more, the abnormality score assigning unit 130 may assign the abnormality score to the abnormal account.

When the abnormal account repeats the same pattern, the abnormality score assigning unit 130 may assign the abnormality score to the abnormal account.

When the abnormal account satisfies a predetermined condition, the abnormality score assigning unit 130 may additionally assign an abnormality score to the abnormal account.

For example, when the abnormal account accessed the game abnormally through a particular internet protocol (IP), the abnormality score assigning unit 130 may additionally assign the abnormality score to the abnormal account.

As another example, when an M number of accounts or more accessed the game through one IP on a certain day and accessed the game through the same IP the next day, the abnormality score assigning unit 130 may additionally assign the abnormality score to the corresponding accounts.

The abnormality score assigning unit 130 may assign the abnormality score by applying a compound-interest weight to an account performing two or more of the foregoing cases.

When the abnormal account satisfies a predetermined condition, the abnormality score assigning unit 130 may deduct the abnormality score of the abnormal account.

For example, when the abnormal account completes a particular instant dungeon, when the abnormal account upgrades a character, when the abnormal account enters a particular instant dungeon, when the abnormal account is reported as a hacking account and then pre-restored, or the like, the abnormality score of the abnormal account may be initialized.

As another example, the abnormality score assigning unit 130 may apply a deduction score as high as M which corresponds to a completed number of character duels, a completed number of particular instant dungeons, a completed number of particular quest performances, or a predetermined period of time.

When the abnormality score assigned to the abnormal account is higher than or equal to a predetermined reference score, the abnormal account detection apparatus 100 may control the abnormal account by a control level corresponding to the predetermined reference score, using the account control unit 140, in operation 240.

When the abnormality score of the at least one other account is higher than or equal to a predetermined reference score, the account control unit 140 may control the at least one other account by a control level corresponding to the predetermined reference score.

When the abnormal account satisfies a predetermined condition, the account control number 140 may cancel the control of the abnormal account.

The account control unit 140 may permanently ban the abnormal account from trading the game goods.

The account control unit 140 may temporarily ban the abnormal account from accessing the game.

The account control unit 140 may permanently ban the abnormal account from accessing the game.

When the abnormality score assigned to a user account is higher than or equal to a predetermined reference score, the abnormal account detection apparatus 100 may control a corresponding account and pop-up a guide window when a corresponding user accesses the game.

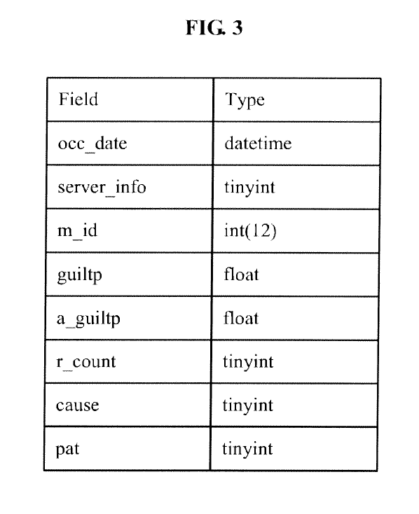

FIG. 3 is a diagram illustrating an example of log data resulting from detection of an abnormal account, according to an embodiment of the present invention.

Referring to FIG. 3, the abnormal account detection apparatus 100 may generate and store log data for analyzing a pattern for assigning an abnormality score.

According to the embodiment of the present invention, the abnormal account detection apparatus 100 may store, as the log data, an occurrence date (occ_date), server information (server_info), a member M identifier (m_id), an abnormality score (guiltp), an accumulated current abnormality score of the abnormal account (a_guiltp), a number of resets of the abnormality score of the abnormal account (r_count), an identifier related to a user assigned the abnormality score (cause), an abnormality score occurrence pattern (pat), and the like.

The abnormality score may be assigned to the abnormal account according to a predetermined pattern so that, when the abnormality score of the abnormal account is higher than or equal to a predetermined reference score, trading of the game goods by the abnormal account may be prevented.

According to the embodiments of the present invention, unfair trades performed by a person who sells game goods for actual money and a hacker may be tracked.

According to the embodiments of the present invention, an economy of the game may be stabilized, thereby increasing reliability of game users with respect to the game.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1-23. (canceled)

24. An abnormal account detection apparatus comprising:
a detection unit to detect an abnormal account from at least one account in a game;
a determination unit to determine whether the abnormal account performs an abnormal trade with at least one account;
an abnormality score assigning unit to assign an abnormality score to the abnormal account according to whether the abnormal account performs the abnormal trade; and
an account control unit to control the abnormal account with a control level corresponding to a predetermined reference score when the abnormality score assigned to the abnormal account is higher than or equal to the predetermined reference score.

25. The abnormal account detection apparatus of claim 24, wherein the detection unit determines the at least one account to be the abnormal account when the at least one account sells at least one item of game goods a predetermined number of times or more.

26. The abnormal account detection apparatus of claim 24, wherein the detection unit inspects transaction data between the abnormal account and at least one other account and, when game goods are traded at a price less than or equal to a predetermined reference price, determines the at least one account and the at least one other account to be the abnormal account.

27. The abnormal account detection apparatus of claim 24, wherein the detection unit determines that the at least one account is the abnormal account when the at least one account repeats the same pattern.

28. The abnormal account detection apparatus of claim 24, wherein the abnormality score assigning unit inspects transaction data between the abnormal account and at least one other account and, when game goods are traded at a price less than or equal to a predetermined reference price, assigns the abnormality score to the at abnormal account and the at least one other account.

29. The abnormal account detection apparatus of claim 28, wherein the account control unit controls the at least one other account with a control level corresponding to the predetermined reference score when the abnormality score assigned to the at least one other account is higher than or equal to the predetermined reference score.

30. The abnormal account detection apparatus of claim 24, wherein the abnormality score assigning unit assigns the abnormality score to the abnormal account when the abnormal account sells at least one item of game goods a predetermined number of times or more.

31. The abnormal account detection apparatus of claim 24, wherein the abnormality score assigning unit assigns the abnormality score to the abnormal account when the abnormal account repeats the same pattern.

32. The abnormal account detection apparatus of claim 24, wherein the account control unit cancels control of the abnormal account when the abnormal account satisfies a predetermined condition.

33. The abnormal account detection apparatus of claim 24, wherein the abnormality score assigning unit additionally assigns the abnormality score to the abnormal account when the abnormal account satisfies a predetermined condition.

34. The abnormal account detection apparatus of claim 24, wherein the abnormality score assigning unit deducts the abnormality score of the abnormal account when the abnormal account satisfies a predetermined condition.

35. The abnormal account detection apparatus of claim 24, wherein the account control unit permanently bans the abnormal account from trading game goods.

36. The abnormal account detection apparatus of claim 24, wherein the account control unit temporarily bans the abnormal account from accessing the game.

37. The abnormal account detection apparatus of claim 24, wherein the account control unit permanently bans the abnormal account from accessing the game.

38. An abnormal account detection method comprising:
detecting an abnormal account from at least one account in a game;
determining whether the abnormal account performs an abnormal trade with at least one account;
assigning an abnormality score to the abnormal account according to whether the abnormal account performs the abnormal trade; and
controlling the abnormal account with a control level corresponding to a predetermined reference score when the abnormality score assigned to the abnormal account is higher than or equal to the predetermined reference score.

39. The abnormal account detection method of claim 38, wherein the detecting of the abnormal account comprises:
determining that the at least one account is the abnormal account when the at least one account sells at least one item of game goods a predetermined number of times or more.

40. The abnormal account detection method of claim 38, wherein the detecting of the abnormal account comprises:
inspecting transaction data between the abnormal account and at least one other account and, when game goods are traded at a price less than or equal to a predetermined reference price, determining that the at least one account and the at least one other account is the abnormal account.

41. The abnormal account detection method of claim 38, wherein the detecting of the abnormal account comprises:
determining the at least one account to be the abnormal account when the at least one account repeats the same pattern.

42. The abnormal account detection method of claim 38, wherein the controlling of the abnormal account comprises:
controlling the at least one other account with a control level corresponding to the predetermined reference score when the abnormality score assigned to the at least one other account is higher than or equal to the predetermined reference score.

43. A non-transitory computer readable recording medium storing a program to cause a computer to implement the method of claim 38.
